(19) United States
(12) Patent Application Publication
(10) Pub. No.: US 2008/0060241 A1
(43) Pub. Date: Mar. 13, 2008

(54) STORE SECURITY DEVICE WITH ATTACHED ADVERTISING SYSTEM

(76) Inventor: Joseph J. Molinaro, North Little Rock, AR (US)

Correspondence Address: BELASCO, JACOBS & TOWNSLEY LLP;HOWARD HUGHES CENTER, 6100 CENTER DRIVE, SUITE 630, LOS ANGELES, CA, 90045, US

(21) Appl. No.: 11/937,418

(22) Filed: Nov. 8, 2007

Related U.S. Application Data
(63) Continuation-in-part of application No. 10/872,178, filed on Jun. 18, 2004, now Pat. No. 7,299,578.

(51) Int. Cl. G09F 15/00; G06T 1/00

(52) U.S. Cl. 40/606.1; 345/418

(57) ABSTRACT

A store security device with attached advertising system includes a store security system for detecting magnetic tags attached to merchandise. The security device includes a magnetic sensor mounted in a frame attached to a base. A cover having first and second side panels and displaying advertising on at least one panel includes an aperture for the sensor and is sized and shaped to fit slidably over the frame. The side panels may include one or more pockets for dispensing promotional materials. An electronic image display may be affixed to the cover or attached directly within the frame, or on the top or side of the frame. Images can be changed on the display in response to motion detectors, as the result of voice activation or based upon a stored program. The image display may be linked to a computer over a network. The images shown may be accompanied by sound.

### RELATED APPLICATION

This application is a continuation-in-part application of U.S. Application Serial No. 10/872,178, filed Jun. 18, 2004.

### FIELD OF INVENTION

The invention pertains to in-store advertising. More particularly, the invention relates to the use of store security devices in combination with fitted covers that include promotional material, advertising and visual displays.

### BACKGROUND OF THE INVENTION

Store security systems are used in conjunction with magnetic tagging devices affixed to merchandise. The tagging devices are removed or deactivated at the checkout counter at the time of purchase. The security system is typically positioned at a store exit and will detect the passage of any tagging device that has not bee deactivated or removed. The security system may emit an alerting sound or provide remote notification to security personnel. The detecting portion of the security system is typically housed in a vertically oriented framework near the store exit and can have an off putting effect on customers. The presence of the devices says, in effect, “this store assumes its customers may attempt to steal merchandise.”Being relatively large (approximately 4 feet high and 2 feet wide), the security devices are easily noticed. For this reason, the instant invention contemplates using this easily noticed store fixture to provide a medium for promotional messages and advertising. In most store locations the security devices are noticeable upon entrance into the store as well as upon exit. Thus any advertisement for goods sold within the store would be visible to the customer just as he enters the store. Various frames and fixtures have been developed to hold advertising displays, however, none have been designed to work in conjunction with store security devices or systems. U.S. Pat. No. 5,966,857, issued to Pettersson et al., discloses an advertising display. The disclosed device is an advertising display that is easily erected and may be used as a freestanding display or as a hanging display. The device is not specifically designed for use with store security devices. The display includes sub-assemblies can slip over one another to be easily replaced with new sub-assemblies containing different advertising.

U.S. Pat. No. 5,787,621, issued to Leskell, is directed to a display stand. This stand is described as being used with bases and, alternatively, without the provided bases. The display units or sub-assemblies described mount around and atop the base and then rest either on the base or upon each other. The display units are stacked on support columns. The lower edges of an upper section of the support connectors come to rest on an upper end of a display stand. The display portion extends below the upper section of the support connectors such that the display portion of the header surrounds the upper end of the display stand. A lower section of the support connectors is sized similar to the connector cards and is similarly received between flaps and free edges of the top of the upper support column.

U.S. Pat. No. 5,860,237, issued to Johnson, discloses a sleeve sign and stand. The sign stand includes a frame and a base. The frame comprises a top, a first vertical column, and a second vertical column. A first or outer vertical edge section of a vertical column and a second outer vertical edge surface of a second vertical column support a sleeve when the sleeve is stretched over the frame. The outer surface of the column comprises a plurality of raised portions and recessed portions. Recessed portions serve to receive and support the sleeve in the installed condition. The raised portions serve to retain the sleeve on vertical surface by requiring the sleeve to stretch further in order to move up or down on the vertical surface. The raised portions form a smooth wave. The vertical surface comprises similar raised portions and recessed portions. The plurality of raised portions and recessed portions of sign stand allows different numbers and heights of sleeves to be used with the same sign stand.

U.S. Pat. No. 4,944,971, issued to McLaughlin, is directed to automobile “sun visor slip covers”. The slip cover has a shape that generally matches that of the sun visor, and thus is elongate and includes two longitudinal side edges and two end edges, all bordering the central body having a first surface and a second surface. The sun visor will have a prescribed width and length, and thus, the cover has a length as measured between the two end edges and a prescribed width as measured between the two side edges. The slipcover is monolithic and is formed of a material that is stretchable, such as a rubberized or plastic type material. The cover includes an opening that extends from the side edge to a location that is spaced from a side edge. The opening has an undeformed axial extent that is shorter than the width of the sun visor; however, the stretchable nature of the cover permits the opening to be sufficiently enlarged to permit the sun visor to be inserted into the cover via the opening. The slipcover also includes an area on the outer surface thereof on which suitable indicia, such as advertising logos or the like, can be placed.

U.S. Pat. Application No. U.S. 2002/0108279, by Hubbard, II et al., is directed to an advertising cover for insulated beverage box. The box cover has a plurality of clear windows that allow advertising graphics to show through so that when a person is waiting to be served by a server, he or she can view the advertising. The advertising graphics are removable and replaceable so that they can be customized to a particular sporting or entertainment event. The box cover simply slips over the ice chest body and cover.

It is an objective of the present invention to provide a means cover store security devices and provide a more customer-friendly environment. It is a further objective to provide a location for the display of advertising and promotional materials at the entrance of a store. It is a still further objective of the invention to provide such advertising locations without interfering with the operation of the security devices. Finally, it is an objective to provide easily interchangeable covers for security devices that can be manufactured and installed inexpensively.

While some of the objectives of the present invention are disclosed in the prior art, none of the inventions found include all of the requirements identified.

### SUMMARY OF THE INVENTION

The present invention addresses all of the deficiencies of prior art display devices and satisfies all of the objectives described above.

(1) A store security device with attached advertising system is constructed from the following components. A store security device is provided. The device has a sensor, a base, a frame portion extending vertically from the base, and an upper surface. A cover is provided. The cover has a first side panel and a second side panel. The cover is sized and shaped to fit slidably over the frame portion. An aperture is provided. The aperture penetrates at least one of the first and second side panels and is sized, shaped, and disposed to align with the sensor. Advertising material is provided. The advertising material is disposed upon at least one of the first and second side panels.

(2) In a variant of the invention, the side panels are joined at their side edges and form a sleeve.

(3) In another variant, the first and second side panels are joined at their top edges forming a closed top. The top has an upper surface and a lower surface.

(4) In still another variant, the lower surface of the top is located on the upper surface of the store security device.

(5) In yet another variant, the first and second side panels are sized such that the cover is suspended above the base.

(6) In a further variant, at least one pocket is provided. The pocket is located upon at least one of the first and second side panels and is sized and shaped to contain either promotional items or materials.

(7) In still a further variant, at least one receptacle having a transparent outer wall is provided. The receptacle has either an open top or open side and has a closed bottom. Removable advertising media is provided. The media is sized and shaped to fit slidably within the receptacle.

(8) In yet a further variant, the cover is fabricated from material selected from the group consisting of paper, paperboard, plastic and wood.

(9) In another variant of the invention, the first and second side panels are joined at their edges using a method selected from the group consisting of sewing, gluing, stapling and buttoning.

(10) In still another variant, the first and second side panels are joined at their edges using a method selected from the group consisting of sewing, gluing, stapling and buttoning.

(11) In yet another variant, a store security device is provided. The device has a sensor, a base, a frame portion extending vertically from the base, and an upper surface. A cover is provided. The cover consists of a first side panel, a second side panel and a top panel. The cover is sized and shaped to fit slidably over the frame portion. The cover further includes two apertures. The apertures run vertically and are dimensioned to expose at least two complete surfaces of the store security device. Advertising material is provided. The advertising material is located on at least one of the first and second side panels.

(12) In a further variant, a store security device is provided. The device has a sensor, a base, a frame portion extending vertically from the base, and an upper surface. At least one electronic image display is provided. The image display is attached either of directly and indirectly to the frame portion.

(13) In still a further variant, a cover is provided. The cover consists of a first side panel and a second side panel. The cover is sized and shaped to fit slidably over the frame portion. The electronic image display is located on either of the first and second side panels.

(14) In yet a further variant, images displayed upon the electronic image display are changed according to a programmed schedule.

(15) In another variant of the invention, images displayed upon the electronic image display are accompanied by recorded sounds.

(16) In still another variant, images displayed upon the electronic image display are either initiated or changed based upon voice activation.

(17) In yet another variant, images displayed upon the electronic image display are either initiated or changed based upon motion detection.

(18) In a further variant, images displayed upon the electronic image display are provided and scheduled by a computer system.

(19) In still a further variant, the computer system is remotely located from the store security device and connected to the device over a network.

(20) In yet a further variant, images displayed upon the electronic image display are targeted to demographics of customers shopping at stores adjacent the store security device.

(21) In another variant of the invention, the electronic image display is located within outer boundaries of the frame portion.

(22) In still another variant, the electronic image display is located upon the upper surface of the frame portion.

(23) In a final variant, the electronic image display is located upon a side member of the frame portion.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a perspective view of the preferred embodiment of the invention including a store security device with removable cover having advertising on an outer surface;

FIG. 2 is a perspective view of a second embodiment of the invention in which the side panels are joined at their side edges;

FIG. 3 is a perspective view of a third embodiment of the invention in which the side panels are joined at their top edges;

FIG. 4 is a perspective view of the FIG. 1 embodiment of the invention in which the side panels are suspended above the security device base;

FIG. 5 is a perspective view of the FIG. 1 embodiment of the invention further including a pocket for promotional materials;

FIG. 6 is a perspective view of the FIG. 1 embodiment of the invention further including a receptacle for removable promotional or advertising materials with a top opening;

FIG. 7 is a perspective view of a fourth embodiment of the invention in which the side panels are joined at their top edges and side edges with apertures provided for the sensors;

FIG. 8 is a perspective view of a fifth embodiment of the invention in which an electronic image display is attached in a central portion of the store security device that also illustrates a speaker system linked to the display images;

FIG. 9 is a perspective view of a sixth embodiment of the invention in which an electronic image display is to an upper surface of the store security device that also illustrates a motion detector system for activating the image display;

FIG. 10 is a perspective view of a seventh embodiment of the invention in which an electronic image display is attached to a side edge of the store security device that also illustrates a voice recognition system linked to the display images; and

FIG. 11 is a perspective view of an eighth embodiment of the invention in which an electronic image display is attached to a cover over the store security device.

### DETAILED DESCRIPTION OF THE PREFERRED EMBODIMENT

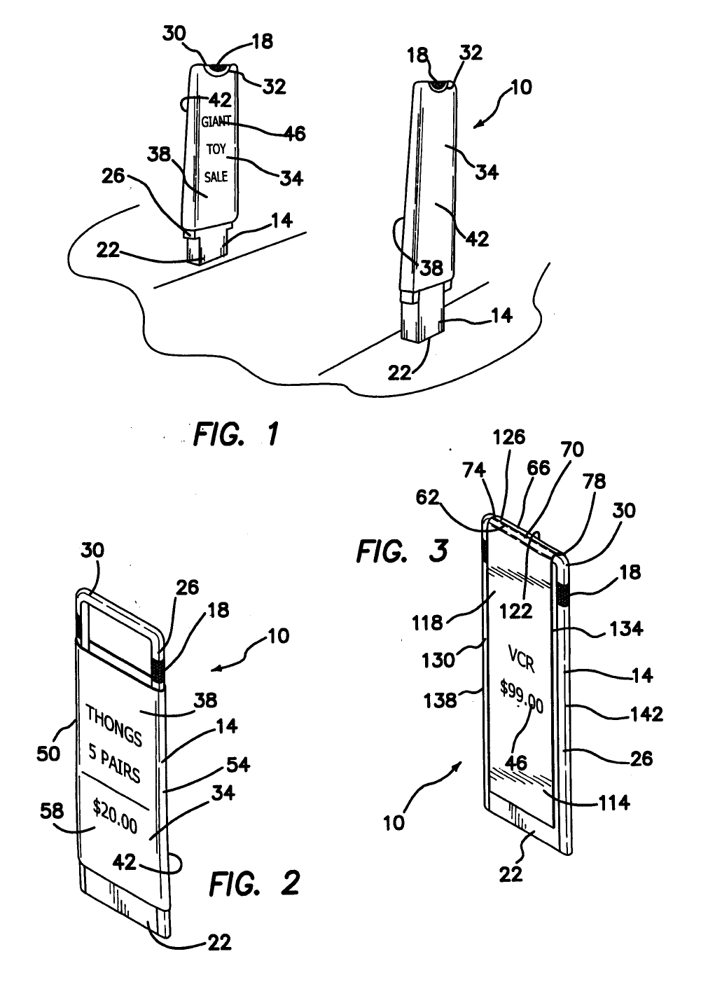

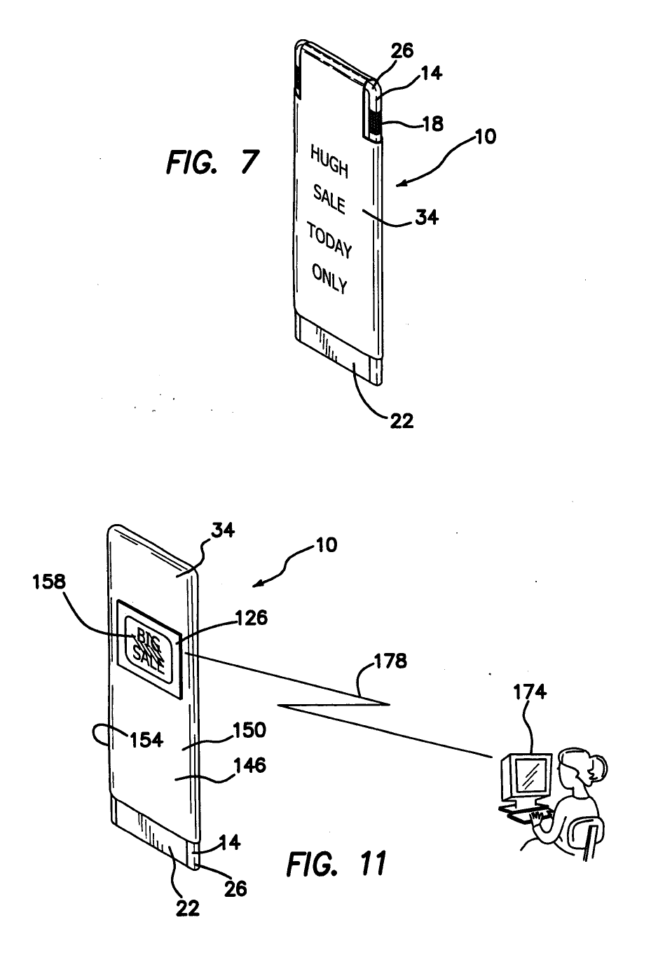

(1) A store security device with attached advertising system 10 is constructed from the following components is illustrated in FIGS. 1-10. A store security device 14 is provided as illustrated in FIG. 1. The device 14 has a sensor 18, a base 22, a frame portion 26 extending vertically from the base 22, and an upper surface 30. A cover 34 is provided. The cover 34 has a first side panel 38 and a second side panel 42. The cover 34 is sized and shaped to fit slidably over the frame portion 26. An aperture 32 is provided. The aperture 32 penetrates at least one of the first 38 and second 42 side panels and is sized, shaped, and disposed to align with the sensor 18. Advertising material 46 is provided. The advertising material 46 is disposed upon at least one of the first 38 and second 42 side panels.

(2) In a variant of the invention, as illustrated in FIG. 2, the side panels 34, 38 are joined at their side edges 50, 54 and form a sleeve 58.

(3) In another variant, as illustrated in FIG. 3, the first 38 and second 42 side panels are joined at their top 62, 66 edges forming a closed top 70. The top 70 has an upper surface 74 and a lower surface 78.

(4) In still another variant, the lower surface 78 of the top 70 is located on the upper surface 30 of the store security device 14.

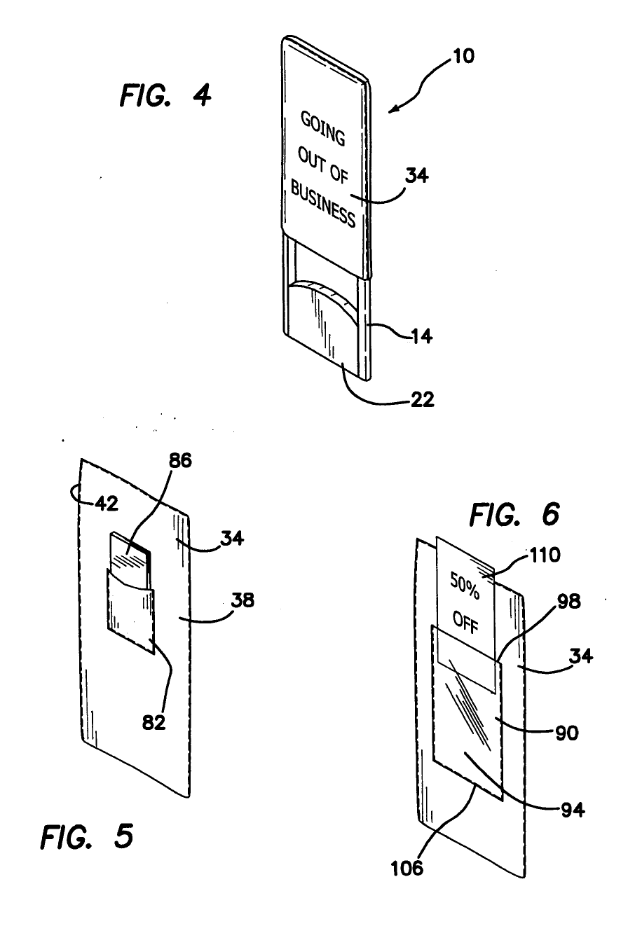

(5) In yet another variant, as illustrated in FIG. 4, the first 38 and second 42 side panels are sized such that the cover 34 is suspended above the base 22.

(6) In a further variant, as illustrated in FIG. 5, at least one pocket 82 is provided. The pocket 82 is located upon at least one of the first 38 and second 42 side panels and is sized and shaped to contain either promotional items or materials 86.

(7) In still a further variant, as illustrated in FIG. 6, at least one receptacle 90 having a transparent outer wall 94 is provided. The receptacle 90 has either an open top 98 or open side (not shown) and has a closed bottom 106. Removable advertising media 110 is provided. The media 110 is sized and shaped to fit slidably within the receptacle 90.

(8) In yet a further variant, the cover 34 is fabricated from material selected from the group consisting of paper, paperboard, plastic and wood.

(9) In another variant of the invention, the first 38 and second 42 side panels are joined at their edges 50, 54 using a method selected from the group consisting of sewing, gluing, stapling and buttoning.

(10) In still another variant, the first 38 and second 42 side panels are joined at their edges 50, 54 using a method selected from the group consisting of sewing, gluing, stapling and buttoning.

(11) In yet another variant, as illustrated in FIG. 3, a store security device 14 is provided. The device 14 has a sensor 18, a base 22, a frame portion 26 extending vertically from the base 22, and an upper surface 30. A cover 114 is provided. The cover 114 consists of a first side panel 118, a second side panel 122 and a top panel 126. The cover 114 is sized and shaped to fit slidably over the frame portion 26. The cover 114 further includes two apertures 130, 134. The apertures 130, 134 run vertically and are dimensioned to expose at least two complete surfaces 138, 142 of the store security device 14. Advertising material 46 is provided. The advertising material 46 is located on at least one of the first 118 and second 122 side panels.

(12) In a further variant, as illustrated in FIGS. 8-11, a store security device 14 is provided. The device 14 has a sensor 18, a base 22, a frame portion 26 extending vertically from the base 22, and an upper surface 30. At least one electronic image display 126 is provided. The image display 126 is attached either of directly and indirectly to the frame portion 26.

(13) In still a further variant, as illustrated in FIG. 11, a cover 146 is provided. The cover 146 consists of a first side panel 150 and a second side panel 154. The cover 146 is sized and shaped to fit slidably over the frame portion 26. The electronic image display 126 is located on either of the first 150 and second 154 side panels.

(14) In yet a further variant, images 158 displayed upon the electronic image display 126 are changed according to a programmed schedule (not shown).

(15) In another variant of the invention, as illustrated in FIG. 8, images 158 displayed upon the electronic image display 126 are accompanied by recorded sounds 162.

(16) In still another variant, as illustrated in FIG. 10, images 158 displayed upon the electronic image display 126 are either initiated or changed based upon voice activation 166.

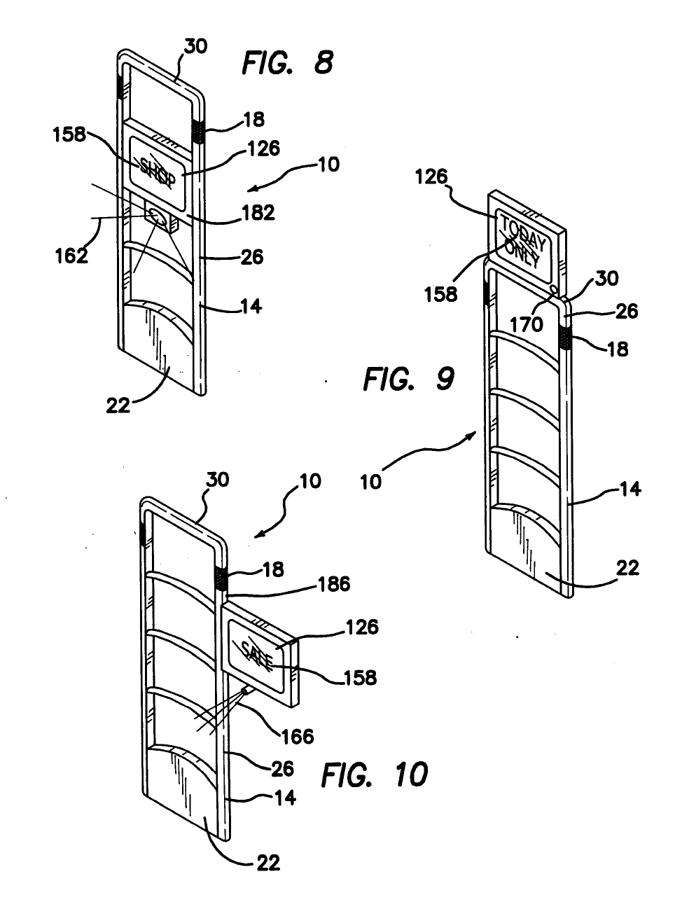

(17) In yet another variant, as illustrated in FIG. 9, images 158 displayed upon the electronic image display 126 are either initiated or changed based upon motion detection 170.

(18) In a further variant, as illustrated in FIG. 11, images 158 displayed upon the electronic image display 126 are provided and scheduled by a computer system 174.

(19) In still a further variant, the computer system 174 is remotely located from the store security device 14 and connected to the device 14 over a network 178.

(20) In yet a further variant, images 158 displayed upon the electronic image display 126 are targeted to demographics of customers (not shown) shopping at stores adjacent the store security device 14.

(21) In another variant of the invention, as illustrated in FIG. 8, the electronic image display 126 is located within outer boundaries 182 of the frame portion 26.

(22) In still another variant, as illustrated in FIG. 9, the electronic image display 126 is located upon the upper surface 30 of the frame portion 26.

(23) In a final variant, as illustrated in FIG. 10, the electronic image display 16 is located upon a side member 186 of the frame portion 26.

The store security device with advertising cover 10 has been described with reference to particular embodiments. Other modifications and enhancements can be made without departing from the spirit and scope of the claims that follow.

1. A store security device with attached advertising system, comprising:
a store security device, said device having a sensor, a base, a frame portion extending vertically from said base, and an upper surface;
a cover, said cover having a first side panel and a second side panel;
said cover being sized and shaped to fit slidably over said frame portion;
an aperture, said aperture penetrating at least one of said first and second side panels and being sized, shaped, and disposed to align with said sensor; and
advertising material, said advertising material being disposed upon at least one of said first and second side panels.

2. The store security device with attached advertising system, as described in claim 1, wherein said side panels are joined at side edges thereof and thereby forming a sleeve.

3. The store security device with attached advertising system, as described in claim 1, wherein said first and second side panels are joined at top edges thereof, thereby forming a closed top, said top having an upper surface and a lower surface.

4. The store security device with attached advertising system, as described in claim 3, wherein said lower surface of said top is disposed upon said upper surface of said store security device.

5. The store security device with attached advertising system, as described in claim 4, wherein said first and second side panels are sized such that said cover is suspended above said base.

6. The store security device with attached advertising system, as described in claim 1, further comprising at least one pocket, said pocket being disposed upon at least one of said first and second side panels and being sized and shaped to contain either of promotional items and materials.

7. The store security device with attached advertising system, as described in claim 1, further comprising:
at least one receptacle having a transparent outer wall, either of an open top and open side and having a closed bottom; and
removable advertising media; said media being sized and shaped to fit slidably within said receptacle.

8. The store security device with attached advertising system, as described in claim 1, wherein said cover is fabricated from material selected from the group consisting of:
paper, paperboard, plastic and wood.

9. The store security device with attached advertising system, as described in claim 2 wherein said first and second side panels are joined at edges thereof using a method selected from the group consisting of:
sewing, gluing, stapling and buttoning.

10. The store security device with attached advertising system, as described in claim 3 wherein said first and second side panels are joined at edges thereof using a method selected from the group consisting of:
sewing, gluing, stapling and buttoning.

11. A store security device with attached advertising system, comprising:
a store security device, said device having a sensor, a base, a frame portion extending vertically from said base, and an upper surface;
a cover, said cover consisting of a first side panel and a second side panel and a top panel;
said cover being sized and shaped to fit slidably over said frame portion;
said cover further comprising two apertures, said apertures running vertically and dimensioned to expose at least two complete surfaces of the store security device; and
advertising material, said advertising material being disposed upon at least one of said first and second side panels.

12. A store security device with attached advertising system, comprising:
a store security device, said device having a sensor, a base, a frame portion extending vertically from said base, and an upper surface; and
at least one electronic image display, said image display being attached either of directly and indirectly to said frame portion.

13. The store security device with attached advertising system, as described in claim 12, further comprising:
a cover, said cover consisting of a first side panel and a second side panel;
said cover being sized and shaped to fit slidably over said frame portion;
said electronic image display being disposed upon either of said first and second side panels.

14. The store security device with attached advertising system, as described in claim 12, wherein images displayed upon said electronic image display are changed according to a programmed schedule.

15. The store security device with attached advertising system, as described in claim 12, wherein images displayed upon said electronic image display are accompanied by recorded sounds.

16. The store security device with attached advertising system, as described in claim 12, wherein images displayed upon said electronic image display are either of initiated and changed based upon voice activation.

17. The store security device with attached advertising system, as described in claim 12, wherein images displayed upon said electronic image display are either of initiated and changed based upon motion detection.

18. The store security device with attached advertising system, as described in claim 12, wherein images displayed upon said electronic image display are provided and scheduled by a computer system.

19. The store security device with attached advertising system, as described in claim 18, wherein said computer system is remotely located from said store security device and connected to said device over a network.

20. The store security device with attached advertising system, as described in claim 12, wherein images displayed upon said electronic image display are targeted to demographics of customers shopping at stores adjacent said store security device.

21. The store security device with attached advertising system, as described in claim 12, wherein said electronic image display is disposed within outer boundaries of said frame portion.

22. The store security device with attached advertising system, as described in claim 12, wherein said electronic image display is disposed upon said upper surface of said frame portion.

23. The store security device with attached advertising system, as described in claim 12, wherein said electronic image display is disposed upon a side member of said frame portion.
